(19) United States
(12) Patent Application Publication
(10) Pub. No.: US 2011/0277334 A1
(43) Pub. Date: Nov. 17, 2011

(54) CLOTH TREATING APPARATUS

(76) Inventors: Yongju Lee, Changwon-si (KR); Sangik Lee, Changwon-si (KR); Hyunwoo Noh, Changwon-si (KR)

(21) Appl. No.: 13/096,402

(22) Filed: Apr. 28, 2011

(30) Foreign Application Priority Data
Apr. 28, 2010 (KR) 10-2010-0039368
Apr. 28, 2010 (KR) 10-2010-0039373
May 4, 2010 (KR) 10-2010-0041999
May 7, 2010 (KR) 10-2010-0042777

(51) Int. Cl. F26B 21/00

(52) U.S. Cl. 34/73

(57) ABSTRACT

The present invention relates to a cloth treating apparatus, including a cabinet which forms an exterior thereof, a drum rotatably mounted to the cabinet, a heat pump for supplying hot air to the drum, a steam generator for supplying steam to the drum, and a water tank for supplying water to the steam generator, wherein the water tank is positioned on a refrigerant flow passage of the heat pump, thereby increasing steam generating efficiency by elevating an initial temperature of the water used for the steam generation.

### CROSS REFERENCE TO RELATED APPLICATION

Pursuant to 35 U.S.C. §119(a), this application claims the benefit of earlier filing date and right of priority to Korean Patent Application Nos. 10-2010-0042777, filed on May 7, 2010, 10-2010-0039373 filed on Apr. 28, 2010, 10-2010-0041999 filed on May 4, 2010 and 10-2010-0039368 filed on Apr. 28, 2010, which are hereby incorporated by references as if fully set forth herein.

### BACKGROUND OF THE DISCLOSURE

1. Field of the Disclosure

The present invention relates to cloth treating apparatuses, and more particularly, to a cloth treating apparatus in which a heat pump supplies hot air to a drum, and has an improved supply structure of water to be used for supplying steam.

2. Discussion of the Related Art

Recently, along with washing machines which wash clothes, different kinds of cloth treating apparatuses are used, such as drum type dryers for drying wet washed clothes, and cabinet type cloth treating apparatuses in which the wet washed clothes is hung for drying.

In the meantime, of the cloth treating apparatuses, dryers and the like for drying the clothes heats air mostly with a heater to supply the hot air to the clothes. In the heaters, there are gas type heaters which burn gas for heating the air, and electric type heaters which heat the air with electric resistance. Recently, a cloth treating apparatus has been developed, which generates the hot air with a heat pump that utilizes an evaporator, a compressor, a condenser, and an expansion valve through which refrigerant circulates, and a fan. It is a trend that a range of use of the heat pump is becoming wider, gradually.

However, since the heat pump has a temperature elevating range lower than the electric type heater or the gas type heater, the heat pump has relatively low air heating efficiency, to require a longer drying time period.

Moreover, accumulation of lint carried by the air both on the evaporator which removes moisture from the air and the condenser which heats the air of the heat pump makes heat efficiency poor.

In the meantime, currently, cloth treating apparatuses having steam generators have been developed and used widely for supplying the steam to the clothes to remove crumples or odor from the clothes. The cloth treating apparatuses having steam generators consume energy additionally compared to the cloth treating apparatus without the steam generator.

### SUMMARY OF THE DISCLOSURE

Accordingly, the present invention, devised to solve above problems, is directed to a cloth treating apparatus.

An object of the present invention, devised to solve above problems, is to provide a cloth treating apparatus in which structures of a heat pump and a steam generator which generate heat in the cloth treating apparatus to generate hot air and steam are improved for reducing power required for steam generation and increasing steam generating efficiency.

Another object of the present invention, devised to solve above problems, is to provide a cloth treating apparatus in which a plurality of evaporators and condensers are provided for enhancing condensing efficiency and heating efficiency, and accurate refrigerant temperature sensing is made for controlling a driving speed of a compressor to suppress noise and vibration generation to minimum.

Another object of the present invention, devised to solve above problems, is to provide a cloth treating apparatus which can remove lint carried by the air and accumulated on heat exchangers from the heat exchangers, such as a condenser or an evaporator.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a cloth treating apparatus includes a cabinet which forms an exterior thereof, a drum rotatably mounted to the cabinet, a heat pump for supplying hot air to the drum, a steam generator for supplying steam to the drum, and a water tank for supplying water to the steam generator, wherein the water tank is positioned on a refrigerant flow passage of the heat pump.

Preferably, the heat pump includes a compressor for supplying refrigerant, a condenser for heating air by means of heat exchange with the refrigerant supplied by the compressor, a flow passage of the refrigerant which passes through the condenser for heating the water being supplied to the steam generator, an expander for expansion of the refrigerant which passes through the condenser, and an evaporator for condensing the air by means of heat exchange with the refrigerant.

Preferably, the steam generator includes a steam generating unit for generating the steam, and a water supply unit for holding the water to be supplied to the steam generating unit, wherein the flow passage heats the water held in the water supply unit.

Preferably, the flow passage is lead into the water supply unit.

Preferably, the cloth treating apparatus further includes a drying duct which forms a hot air moving passage, and the heat pump is coupled to the drying duct to form a modular shape.

Preferably, the evaporator includes a first evaporator and a second evaporator arranged adjacent to the first evaporator, such that humid air from the drum passes through the first evaporator and the second evaporator in succession through one flow passage.

Preferably, the condenser includes a first condenser and a second condenser arranged adjacent to the first condenser, such that dried air passed through the evaporator passes through the first condenser and the second condenser in succession through one flow passage.

Preferably, the compressor is a variable compressor, and at least one temperature sensor is provided for sensing a temperature of the evaporator, the variable compressor, the condenser, the expansion valve, and a phase change temperature of the refrigerant.

Preferably, the evaporator includes a refrigerant line through which the refrigerant flows, and heat exchange fins fixedly secured to the refrigerant line, and the temperature sensor is mounted in the vicinity of a middle portion of the refrigerant line exposed from the heat exchange fins.

Preferably, the condenser includes a refrigerant line through which the refrigerant flows, and heat exchange fins fixedly secured to the refrigerant line, and the temperature sensor is mounted in the vicinity of a middle portion of the refrigerant line exposed from the heat exchange fins.

Preferably, the heat pump further includes lint removing means for removing lint from the heat pump.

Preferably, the lint removing means includes a spray nozzle for receiving the condensed water from the evaporator and spraying the condensed water to the evaporator at a predetermined pressure.

Preferably, the lint removing means further includes a fan for blowing air to the drum, and the fan is provided as a reversible fan which can blow the air in regular/opposite directions for blowing the air in a direction opposite to a direction of the air blow at the time of drying at the time of lint removal.

In another aspect of the present invention, a cloth treating apparatus includes a cabinet which forms an exterior thereof, a drum rotatably mounted to the cabinet, a heat pump for supplying hot air to the drum, and a steam generator for supplying steam to the drum, wherein the water supplied to the drum is pre-heated by surplus heat of the heat pump.

In another aspect of the present invention, a cloth treating apparatus for washing and drying clothes, includes a heat pump for supplying hot air for drying the clothes, and a steam generator for supplying steam to the clothes for refreshing the clothes, wherein the water supplied to the steam generator is pre-heated by surplus heat of the heat pump.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates an exploded perspective view of a cloth treating apparatus in accordance with a preferred embodiment of the present invention.

FIG. 2 illustrates a longitudinal section of a cloth treating apparatus in accordance with a preferred embodiment of the present invention, schematically.

FIG. 3 illustrates a perspective view of a heat pump module in a cloth treating apparatus in accordance with a preferred embodiment of the present invention.

FIG. 4 illustrates a block diagram of a heat pump and a steam generator in a cloth treating apparatus in accordance with a preferred embodiment of the present invention.

FIGS. 5 and 6 illustrate schematic views of heat pump modules in accordance with a preferred embodiment of the present invention, respectively.

FIGS. 7 and 8 illustrate schematic views of lint removing means from heat pump modules in accordance with preferred embodiments of the present invention, respectively.

FIG. 9 illustrates a block diagram of a cloth treating apparatus in accordance with a preferred embodiment of the present invention.

FIG. 10 illustrates a block diagram of a cloth treating apparatus in accordance with another preferred embodiment of the present invention.

### DESCRIPTION OF SPECIFIC EMBODIMENTS

Terms of elements defined in describing the present invention have been made taking functions thereof in the present invention into account. Therefore, it is required to understand that the terms do not limit technical elements of the present invention. Moreover, the terms of the elements may be called in other terms in this field of art.

In order to describe the cloth treating apparatus of the present invention, a drum type cloth treating apparatus will be taken as an example for convenience's sake. However, the present invention is not limited to this, but the cloth treating apparatus of the present invention is applicable to a cabinet type cloth treating apparatus having immovable drying space, and a washing machine having a drying function.

And, the drying objects mentioned in this specification includes, not only clothes, apparel, but also objects people uses, such as a doll, a handkerchief, blanket, along with objects a person can wear, such as shoes, socks, gloves, a headgear, a muffler, i.e., all objects requiring washing.

Reference will now be made in detail to the specific embodiments of the present invention, examples of which are illustrated in the accompanying drawings. Wherever possible, the same reference numbers will be used throughout the drawings to refer to the same or like parts.

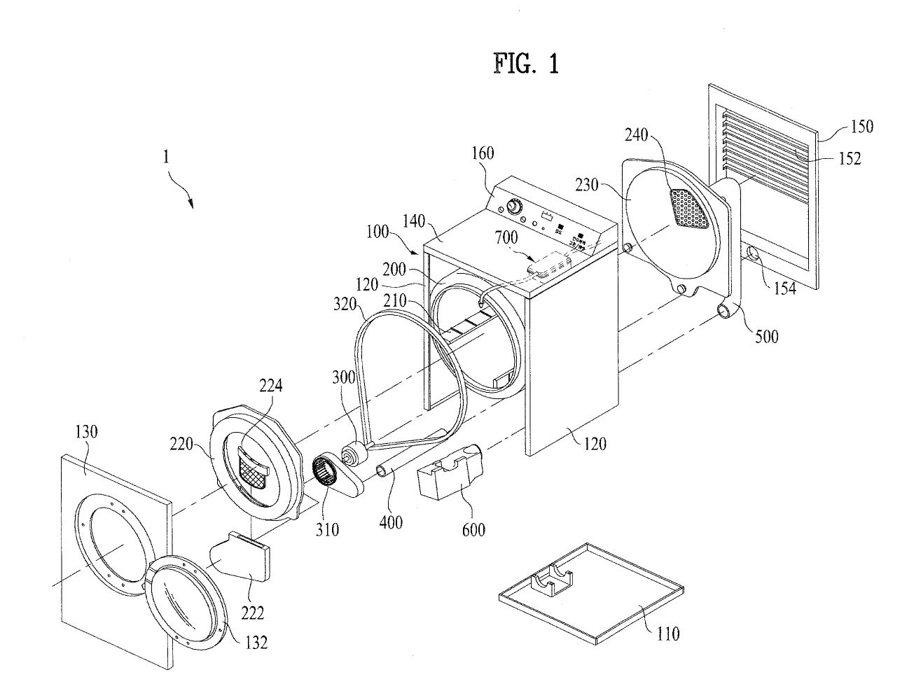

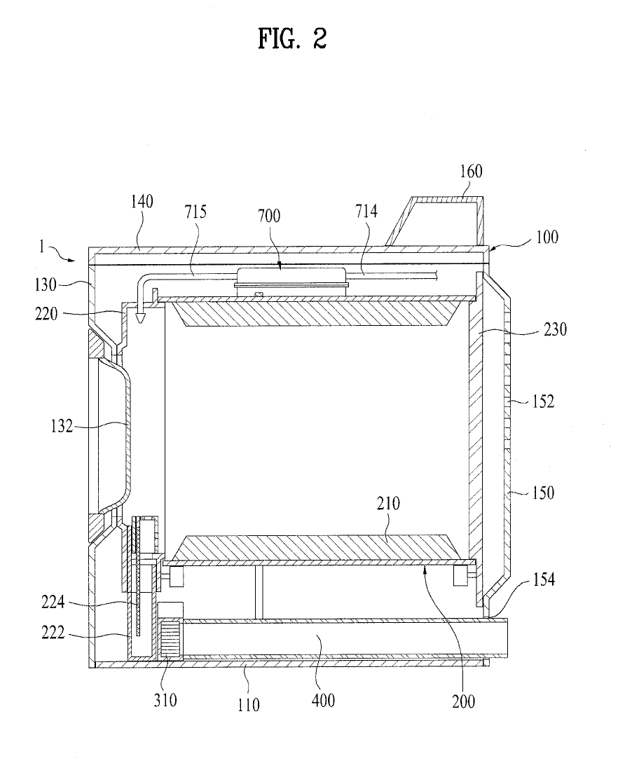

FIG. 1 illustrates an exploded perspective view of a cloth treating apparatus in accordance with a preferred embodiment of the present invention. FIG. 2 illustrates a longitudinal section of a cloth treating apparatus in accordance with a preferred embodiment of the present invention, schematically.

Referring to FIGS. 1 and 2, the cloth treating apparatus 1 includes a cabinet 100 which forms an exterior thereof, a drum 200 rotatably mounted to the cabinet 100, a motor 300 and a belt 320 for rotating the drum 200, a heat pump 600 for supplying high temperature air (Hot air) to the drum, a steam generator 700 for supplying steam to the drum 200, and an air discharge duct 400 for discharging humid air heat exchanged with laundry in the drum 200, wherein the steam generator 700 is provided to a position of the cabinet 100 for generating and supplying hot steam to the drum 200.

The cabinet 100, which forms an exterior of the cloth treating apparatus 1, includes a base 110 which forms a bottom surface thereof, one pair of side covers 120 vertically mounted to the base 110 respectively, a front cover 130 and a rear cover 150 mounted to fronts and rears of the side covers 120 respectively, and a top cover 140 position on a top of the side covers 120. There are a control panel 160 positioned, in general, at the top cover 140 or the front cover 130, and a door 132 mounted to a front cover 130. The rear cover 150 has an air inlet 152 for introduction of external air, and an air outlet 154 for final discharge of air from the drum 200 to an outside of the cloth treating apparatus.

The drum 200 has a laundry space formed therein for holding laundry and serving as a drying chamber to dry the laundry. It is preferable that lifts 210 are mounted in the drum 200 for lifting up and dropping down the laundry to turn over the laundry for improving drying efficiency.

In the meantime, between the drum 200 and the cabinet 100, i.e., between the drum 200 and the front cover 130 and the rear cover 150, there are a front supporter 220 and a rear supporter 230 mounted thereto, respectively. The drum 200 is rotatably mounted between the front supporter 220 and the rear supporter 230, and there are sealing members (not shown) mounted between the front supporter 220 and the drum 200 and between the rear supporter 230 and the drum 200, respectively for leakage prevention. That is, the front supporter 220 and the rear supporter 230 cover the front and the rear of the drum 200 to form a drying chamber, and serve to support a front end and a rear end of the drum 200.

The front supporter 220 has an opening for making the drum 200 to be in communication with an outside of the cloth treating apparatus. The opening is opened/closed by a door 132, selectively. The front supporter 220 also has a lint duct 222 which is a passage connected thereto for discharging air from the drum 200 to an outside of the cloth treating apparatus. The lint duct 222 has a lint filter 224 mounted thereto.

There is a fan 310 having one side connected to the lint duct 222 and the other side connected to the discharge duct 400 in communication with the air outlet 154 in the rear cover 150.

Therefore, upon putting the fan 310 into operation, the air is discharged to the outside of the cloth treating apparatus passing through the lint duct 222, the discharge duct 400, and the air outlet 154 in succession. In this case, foreign matter, such as lint, is filtered at the lint filter 224. In general, the fan 310 has a blower and a blower housing, and in general, the blower is connected to the motor 300 which drive the drum.

In general, the rear supporter 230 has an opening 240 having a plurality of pass through holes to which a drying duct 500 is connected. The drying duct 500 is in communication with the drum 200 to serve as a passage for supplying dried air to the drum 200. Accordingly, the drying duct 500 is connected to the heat pump 600. In the meantime, there is a steam generator 700 mounted to a position of the cabinet 100 for generating and supplying steam to the drum 200.

The heat pump 600 and the steam generator 700 in accordance with a preferred embodiment of the present invention will be described in detail with reference to the attached drawings.

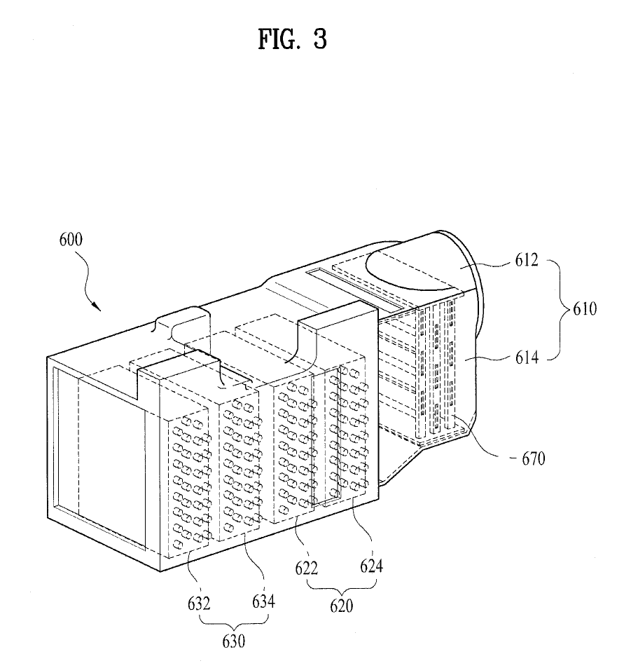

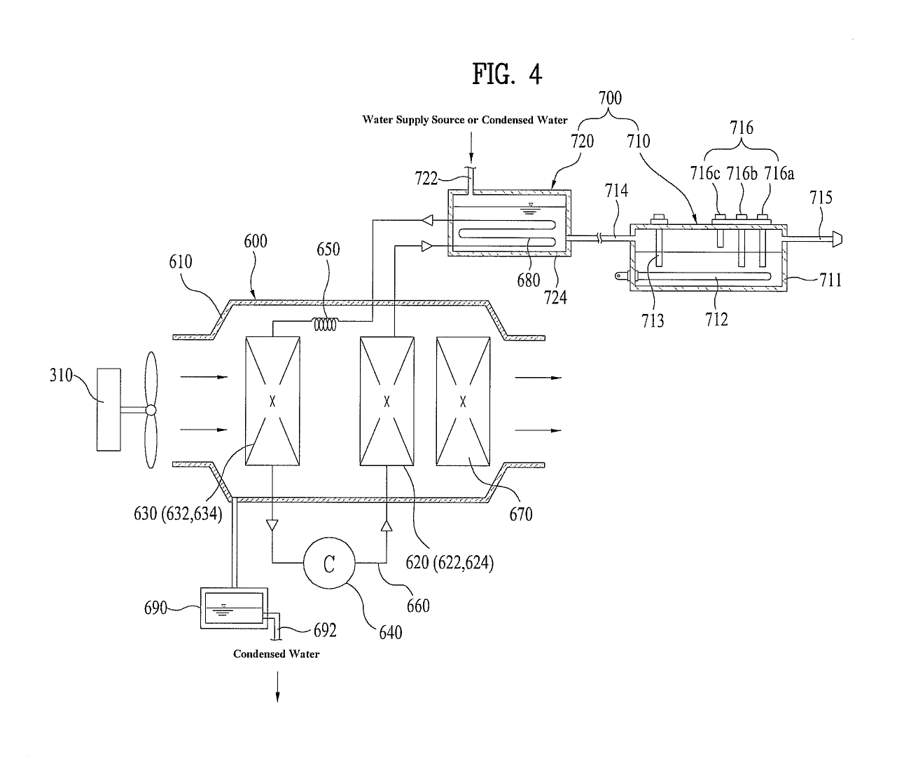

FIG. 3 illustrates a perspective view of a heat pump module in a cloth treating apparatus in accordance with a preferred embodiment of the present invention, and FIG. 4 illustrates a block diagram of a heat pump and a steam generator in a cloth treating apparatus in accordance with a preferred embodiment of the present invention.

As shown, the heat pump 600 and the steam generator 700 are provided to operate in association with each other. That is, surplus heat of the heat pump 600 is used for pre-heating water used for generating the steam.

Referring to FIGS. 3 and 4, a structure of the heat pump 600 will be described. The heat pump 600 includes a compressor 640, an evaporator 630, an expansion valve 650, a condenser 620, and so on for circulating refrigerant to dry and heat the air introduced thereto from an outside of the cloth treating apparatus, appropriately.

That is, the heat pump 600 absorbs latent heat from the air introduced thereto from an outside of the cloth treating apparatus owing to condensation of the refrigerant to condense moisture in the air, and includes the evaporator 630 for transferring the latent heat to the condenser 620 which will be described later, and the condenser 620 for heating the air with the latent heat from the evaporator 630 transmitted through the refrigerant. That is, the heat pump 600 of the embodiment can supply dried hot air to the drum 200 as the evaporator 630 removes moisture from the air, and the condenser 620 heats the air to a predetermined temperature.

Even though elements of the heat pump 600 can be mounted to one side of the cabinet 100, preferably a modular heat pump 600 can be detachably mounted to one side of the cabinet 100 as shown in the drawings. The modular heat pump 600 permits easy disassembly of the cloth treating apparatus of the present invention in assembly and maintenance of the cloth treating apparatus.

For this, the heat pump 600 of the embodiment can include a case 610 which forms an exterior thereof and encases different element thereof described before. The case 610 can include an upper case 612 and a lower case 614, and the different elements described before can be mounted to the lower case 614. The upper case 612 can be detachably mounted to the lower case 614. Owing to this, mounting and maintenance of the different elements in the case 610 become easier.

In the meantime, the compressor 640 can be mounted, separate from, or to an inside of, the case 610, for supplying refrigerant to the evaporator 630. And, the evaporator 630 and the condenser 620 are mounted in the case 610 side by side in a flow direction of the air. In this instance, the evaporator 630 condenses moisture in the air introduced thereto from an outside of the cloth treating apparatus for drying the air. That is, the refrigerant evaporated in the evaporator 630 absorbs heat from the air which passes an outside of the evaporator 630, such that the moisture in the air is cooled down into condensed water and the air has the moisture removed therefrom to become the dried air.

In the meantime, the heat pump 600 can have a condensed water tank 690 for holding the condensed water from the evaporator 630, additionally. In this instance, the condensed water tank 690 can have a configuration in which the condensed water is drained to an outside of the cloth treating apparatus 1 through a drain pipe (not shown), or the condensed water tank 690 is detachably mounted to the cabinet 100 so that the user detaches the condensed water tank 690 and drains the condensed water. The condensed water tank 690 has a condensed water supply line 692 for supplying the condensed water from the condensed water tank 690 to a water supply unit 720 of the steam generator 700.

In the meantime, the evaporator 630 can condense the water in the air to dry the air, and, at the same time with this, the refrigerant in the evaporator 630 can store the latent heat. That is, as the moisture in the air is condensed, the refrigerant in the evaporator 630 is vaporized to contain the latent heat. The latent heat contained in the refrigerant is transferred to the condenser 620 described later and used for heating the air.

The condenser 620 is provided to generate the hot air by heating the air passed through the evaporator 630. That is, the refrigerant containing the latent heat is supplied from the evaporator 630 to the condenser 620 through the compressor via a refrigerant pipe 660, and the refrigerant discharges the latent heat as the refrigerant is condensed at the condenser 620 to heat the air flowing through the condenser 620 to a predetermined temperature.

Accordingly, the evaporator 630 condenses the moisture in the air to dry the air as well as transfers the latent heat discharged by condensation of the moisture to the condenser 620 through the refrigerant, and the condenser 620 heats the air by discharging the latent heat by condensation of the refrigerant.

In the meantime, the embodiment has the case 610 mounted to the heat pump 600 to form an air flow passage for the air to flow along the evaporator 630 and the condenser 620. That is, the air introduced to the case 610 of the heat pump 600 is dried as the moisture thereof is condensed at the evaporator 630, and, then, can be supplied to the drum 200 after heated at the condenser 620 after the compressor 640. If one air flow passage is formed thus, drying effect can be improved further because the air being supplied to the drum 200 is in a heated and dried state. In general, in order to improve the drying effect, what is required is not only supply of hot air, but also supply of dried air.

Though a shape of the air flow passage is not limited, the shape of the air flow passage can be a straight type taking a fact that the heat pump 600 is mounted in the cabinet 100 into account. For this, the evaporator 600 and the condenser 620 of the heat pump 600 can be arranged on a line along the air flow passage in a straight type. According to this, a volume of the heat pump 600 can be minimized permitting easier assembly and disassembly of the heat pump 600.

As described before, though the embodiment describes a case the case 610 is provided to the heat pump 600, in a case the elements of the heat pump 600 is mounted to one side of the cabinet 100 without the case 610, an additional duct can be provided for introduction of external air to the evaporator 630 and the condenser 620.

And, though the embodiment describes a configuration in which one air flow passage is formed along the evaporator 630 and the condenser 620 of the heat pump 600, another configuration is also possible in which separate air flow passages are formed along the evaporator 630 and the condenser 620. That is, another configuration is also possible, in which the evaporator 630 condenses the moisture in the air to store the latent heat therein, and discharge the air to an outside of the heat pump 600, while the condenser 620 heats the air introduced thereto through a separate air flow passage with the latent heat transferred to the condenser 620 by the refrigerant for supplying the dried and heated air to the drum 200.

Since the air is heated at the condenser 620 in a case the air is dried and heated at the heat pump 600 for supplying to the drum 200, an air temperature is liable to be lower than a related art cloth treating apparatus which use a heater. Accordingly, the embodiment can have a supplementary heater 670 at an end portion of the case 610 for heating the air.

The supplementary heater 670 can be a gas burner or an electric heater, but not limited to above. If the supplementary heater 670 is provided to the end portion of the flow passage through which the air flows thus, since the air dried and heated by the condenser 620 of the heat pump 600 is heated to a desired temperature by the supplementary heater again, supply of the air at a desired temperature becomes possible. Accordingly, since the air is pre-heated by the condenser 620 and heated by the supplementary heater 670, a load on the supplementary heater 670 can be reduced, significantly. That is, heating of the air to the desired temperature with the supplementary heater 670 by using electric energy smaller than the related art is possible, and moreover, heating of the air with a small sized supplementary heater 670 is possible.

In the meantime, the expansion valve 650 is provided between the condenser 620 and the evaporator 630 for expanding the refrigerant passed through the condenser 620. In this instance, a portion of the flow passage that connects the condenser 620 to the expansion valve 650 is connected to an inside of a water storage tank 724 of the water supply unit 720 in the steam generator 700 to form a pre-heating flow passage for pre-heating the water in the storage tank 724.

That is, the refrigerant heat exchanges with the air while passing through the condenser 620 to heat the air passing through the heat pump 600. In this instance, the refrigerant passing through the condenser 620 has remained heat in a range of about 90˜100?? after the heat exchange is made.

Therefore, the remained heat can pre-heat the water being supplied to the steam generator 700 as the remained heat passes through a pre-heating flow passage 680. In the meantime, a pre-heating structure of the water storage tank 724 of the water supply unit 720 will be described in detail, at the time of description of the steam generator 700.

In the meantime, the steam generator 700 includes a steam generating unit 710 for generating steam, and a water supply unit 720 for supplying the water to the steam generator 700 required for generating the steam.

The steam generating unit 710 includes a heating tank 711 for holding the water, a heater 712 mounted in the heating tank 711, a water level sensor 716 for measuring a water level of the steam generator 700, and a temperature sensor 713 for measuring a temperature of the steam generator 700. In general, the water level sensor 716 has a common electrode 716a, a low water level electrode 716b and a high water level electrode 716c for sensing a high water level or a low water level depending on whether the common electrode 716a and the high water level electrode 716c become conductive or the common electrode 716a and the low water level electrode 716b become conductive.

The steam generating unit 710 has one side connected to a water supply hose 714 for supplying the water, and the other side connected to a steam supply line 715 for discharging the steam, and it is preferable that the steam supply line 715 has a nozzle of a predetermined shape at a fore end thereof.

In general, the water supply hose 714 has one end connected to the water supply unit 720, for supplying the water to the steam generating unit 710, and the fore end or the nozzle of the steam supply line 715, i.e., a steam outlet, is positioned at a predetermined position of the drum 200 for spraying the steam into the drum 200.

The water supply unit 720 has a water storage tank formed to have a shape of container for storage of water supplied thereto separately, the water storage tank 724 has one end connected to the water supply hose 714 for supplying the water to the steam generating unit 710, and the pre-heating flow passage 680 is lead and mounted to an inside of the water storage tank 724 connected from the condenser 620 of the heat pump 600 to the expansion valve 650.

The water supply hose 714 can have the water supplied thereto from a separate water supply source, or connected to the condensed water supply line 692 of the condensed water tank 690 for having the condensed water supplied thereto from the condensed water tank 690. For this, the condensed water supply line 692 can be provided with a pump (not shown) separately for forced supply of the condensed water from the condensed water tank 690.

In the meantime, the pre-heating flow passage 680 lead to the water supply unit 720 can be arranged in zigzag in the water storage tank 724 for increasing a heat generation area. And, in order to increase a heating area, a separate heat exchange heat sink (not shown) can be provided, additionally.

Accordingly, the remained heat of the refrigerant having heated the air while passing through the condenser 620 in the heat pump 600 heats the water stored in the water storage tank 724 while passing through the preheating flow passage 680. Then, the water heated thus is supplied to, and heated additionally at, the steam generating unit 710 to generate the steam. Accordingly, since the water being supplied to the steam generating unit 710 has been pre-heated with the remained heat of the refrigerant, the pre-heated water can increase steam generating efficiency of the steam generating unit 710, and can shorten a steam generating time period.

In the meantime, as described before, the embodiment describes a heat pump 600 having single evaporator 630 and single condenser 620. However, different from this, there can be a heat pump 600 having a plurality of evaporators 630 and a plurality of condensers 620.

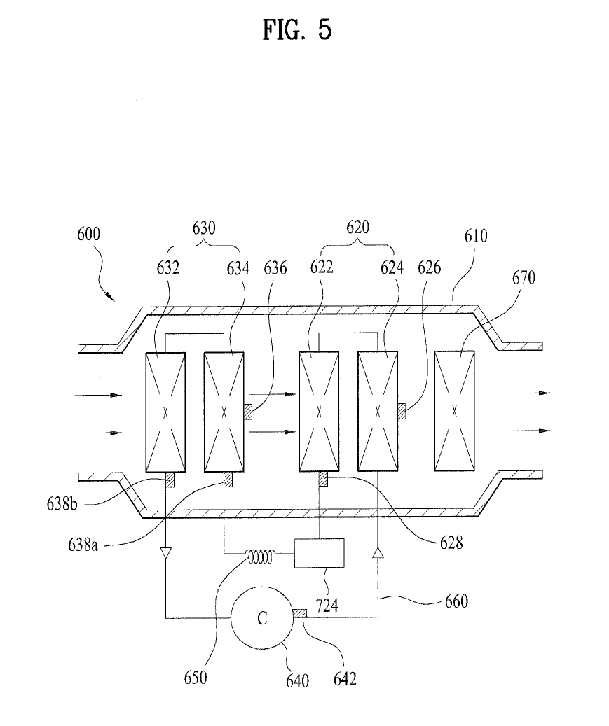

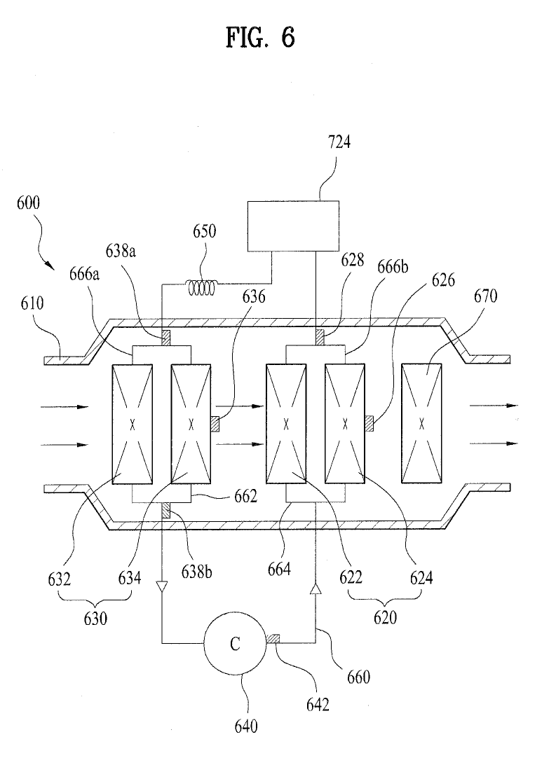

The embodiment will describe a mounting state of the plurality of condensers 620 and the plurality of evaporators 630. FIGS. 5 and 6 illustrate schematic views of heat pump modules in accordance with a preferred embodiment of the present invention, respectively.

As shown, though numbers of the evaporators 630 and the condensers 620 can vary with mounting environments, preferably, the numbers can be two. The embodiment will be described taking an example in which the numbers of the evaporators 630 and the condensers 620 are two, respectively.

The evaporator 630 in accordance with a preferred embodiment of the present invention has a first evaporator 632 and a second evaporator 634. Along with this, the condenser 620 has a first condenser 622 and a second condenser 624. It is preferable that the first evaporator 632 and the second evaporator 634 are arranged adjacent to each other, and the first condenser 622 and the second condenser 624 are arranged adjacent to each other. And, it is preferable that the first and second evaporators and the first and second condensers are arranged in a direction parallel to a flow direction of the air.

In the meantime, the first and second evaporators 632 and 634 and the first and second condensers 622 and 624 are connected to the compressor 640 with refrigerant pipes 660. In this instance, connection of the refrigerant pipes 660 to the first and second evaporators 632 and 634 and the first and second condensers 622 and 624 can be parallel or serial.

If the first and second evaporators 632 and 634 and the first and second condensers 622 and 624 are connected in series, the compressor 640 and the first evaporator 632 are connected with the refrigerant pipe 660, and the first evaporator 632 and the second evaporator 634 are connected with a separate pipe. Accordingly, the refrigerant pipe 660 is connected from the second evaporator 634 to the expansion valve 650, and the refrigerant pipe 660 is connected from the expansion valve 650 to the first condenser 622. And, the first condenser 622 and the second condenser 624 are connected with a separate pipe, and the second condenser 624 and the compressor are connected with the refrigerant pipe 660.

According to this, the refrigerant supplied from the compressor 640 heats the air as the refrigerant passes through the first and second condensers 622 and 624 in succession. And, the refrigerant passed through the first and second condensers 622 and 624 condenses the moisture in the air while passing through the first and second evaporators 632 and 634 via the expansion valve 650.

And, in a case the first and second evaporators 632 and 634 and the first and second condensers 622 and 624 are connected in parallel, branch pipes 662 and 664 can be formed at the refrigerant pipe 660 connected from the compressor 640 to the first evaporator 632 and the second evaporator 634, and the refrigerant pipe 660 connected from the compressor 640 to the first condenser 622 and the second condenser 624, additionally. And, branch pipes 666a and 666b can be formed at the refrigerant pipe 660 connected from the expansion valve 650 to the first evaporator 632 and the second evaporator 634, and at the refrigerant pipe 660 connected from the expansion valve 650 to the first condenser 622 and the second condenser 624, additionally.

Accordingly, as the branch pipe 661 is connected to an end of the refrigerant pipe 660 connected from the compressor 640 to the first and second evaporators 632 and 634, the refrigerant is supplied to the first evaporator 632 and the second evaporator 634 through the branch pipe at the same time. Along with this, as the branch pipe 664 is connected to an end of the refrigerant pipe connected from the first and second condensers 622 and 624 to the compressor 640, the refrigerant passed through the first condenser 622 and the second condenser 624 through the branch pipe 664 is supplied to the compressor 640.

Accordingly, the refrigerant supplied to the compressor 640 condenses the moisture in the air while the refrigerant is divided into two and passes through the first and second evaporators 632 and 634, and heats the air while the refrigerant is divided into two and passes through the first and second condensers 622 and 624.

Accordingly, the humid air from the drum 200 has the moisture therein condensed and removed therefrom during the humid air passes through the first evaporator 632 and the second evaporator 634 in succession. According to this, the humid air becomes dried air. And, the dried air from the evaporator 630 is heated as the dried air passes through the first condenser 622 and the second condenser 624 in succession. Then, the hot air passed through the second condenser 624 is introduced to the drum 200, again.

Since the humid air from the drum 200 passes through the first evaporator 632 and the second evaporator 634 in succession, the cloth treating apparatus in accordance with a preferred embodiment of the present invention has an effect of increasing condensing efficiency. That is, since the humid air passes through the first and second evaporators 632 and 634, increasing a contact area and a contact time period with the refrigerant pipe lines of the first and second evaporators 632 and 634, the cloth treating apparatus of the present invention can condense the moisture in the humid air to the maximum.

Moreover, since the dried air passed through the second evaporator 634 passes through the first condenser 622 and the second condenser 624 in succession, heating efficiency is increased. That is, as the dried air passed through the evaporator 630 passes through the first and second condensers 622 and 624, increasing the contact area and the contact time period of the dried air with the refrigerant line of the first and second condensers 622 and 624, dried air having a temperature higher than the dried air passed through single condenser is obtainable.

Accordingly, heat exchange efficiency can be increased and the drying time period can be shortened by supplying such hot dried air to the drum 200 to heat exchange with drying objects.

In the meantime, as described before, if the heat pump 600 is provided, though the air can be heated and dehumidified by using one device, since the refrigerant can not make adequate heat exchange with the air at the evaporator 630 at an initial stage of driving of the heat pump 600 to fail to vaporize entirely, it is liable that liquid state refrigerant can be introduced to the compressor 640. The introduction of the liquid state refrigerant to the compressor 640 can cause failure of and damage to the compressor 640. Therefore, the cloth treating apparatus 1 having the compressor 640 is required to have a control method for preventing the compressor suffering from damage at the time of initial starting.

In order to solve such a problem, the cloth treating apparatus 1 in accordance with a preferred embodiment of the present invention can be provided with a variable compressor if the cloth treating apparatus has the heat pump 600. The variable compressor can be defined as a compressor of which driving speed hz is not fixed, but can be controlled selectively when the compressor 640 is driven. Therefore, by controlling the driving speed selectively, noise and vibration of the compressor 640 can be reduced, and damage and breakage of the compressor can be prevented.

In the meantime, as a major factor of the control of the driving speed of the variable compressor 640, there is temperature information on the refrigerant. The refrigerant temperature information can include at least one of a refrigerant condensing temperature at the condenser 620, a refrigerant evaporation temperature at the evaporator 630, a discharging refrigerant temperature from the condenser 620, and inlet/outlet refrigerant temperatures to/from the evaporator 630.

That is, the control unit (not shown) of the cloth treating apparatus 1 can control the driving speed of the compressor 640 based on above temperature information on the refrigerant.

A configuration for sensing a temperature of the heat pump will be described in detail.

Referring to FIGS. 5 and 6, the heat pump 600 can include the evaporator 630, the compressor 640, the condenser 620, and the expansion valve 650 which are connected with the refrigerant pipe 660. In order to sense above described pieces of temperature information, the cloth treating apparatus in accordance with the embodiment can be provided with at least one temperature sensor. Of above described pieces of temperature information, in a case the discharging refrigerant temperature from the condenser 620, and the inlet/outlet refrigerant temperatures to/from the evaporator 630 are intended to sense, the temperature sensors 628, 638a, and 638b can be mounted to a refrigerant outlet of the condenser 620, a refrigerant inlet and outlet of the evaporator 630, respectively. In addition to this, if it is intended to sense a refrigerant discharge temperature from the compressor 640, a temperature sensor 642 can be mounted to a refrigerant outlet of the compressor 640.

That is, if the discharging refrigerant temperature from the condenser 620, and the inlet/outlet refrigerant temperatures to/from the evaporator 630 are intended to sense, positions of the temperature sensors 628, 638a, 638b, and 642 do not influence to sensing of the refrigerant temperature, substantially. However, if it is intended to sense the refrigerant condensing temperature at the condenser 620 and the refrigerant evaporation temperature at the evaporator 630, the positions of the temperature sensors 628, 638a, and 638b are important. That is, in order to sense phase change temperatures of the refrigerant at the condenser 620 and the evaporator 630, it is preferable that the temperature sensors 626 and 636 are mounted along refrigerant pipe lines in which the phase changes take place in the condenser 620 and the evaporator 630, respectively.

In the meantime, the evaporator 630 can be have a first temperature sensor 636 for sensing a phase change temperature of the refrigerant, i.e., a vaporizing temperature of the refrigerant, at the evaporator 630. In order to sense the phase change temperature of the refrigerant at the evaporator 630, the first temperature sensor 636 can be mounted to a predetermined position. For an example, the first temperature sensor 636 can be mounted in the vicinity of a middle portion of the refrigerant line provided in the evaporator 630, i.e., in the vicinity of a middle portion along a length of the refrigerant line, substantially. This is because the phase change can take place in the vicinity of the middle portion along the length of the refrigerant line of the evaporator 630, substantially. And, if the phase change of the refrigerant takes place on a side of the refrigerant inlet or outlet of the refrigerant line of the evaporator 630, failing adequate heat exchange with the air, overall efficiency of the heat pump 600 becomes poor. At the end, the phase change of the refrigerant can take place at the middle portion of the length of the refrigerant line of the evaporator 630, and the first temperature sensor 636 can be provided in the vicinity of the length of the refrigerant line of the evaporator 630 for sensing the phase change temperature.

And, the condenser 620 can be provided with a second temperature sensor 626 for sensing the phase change of the refrigerant at the condenser 620, i.e., a condensing temperature of the refrigerant. The second temperature sensor 626 can be provided at a predetermined position for sensing the phase change of the refrigerant at the condenser 620. For an example, the second temperature sensor 626 can be provided at a middle portion of the refrigerant line provided in the condenser 620 substantially, i.e., in the vicinity of the middle portion of a length of the refrigerant line. This is because the phase change can take place in the vicinity of the middle portion of the length of the refrigerant line of the condenser 620. And, if the phase change of the refrigerant takes place on a side of the refrigerant inlet or outlet of the refrigerant line of the condenser 620, failing adequate heat exchange with the air, overall efficiency of the heat pump 600 becomes poor. At the end, the phase change of the refrigerant can take place at the middle portion of the length of the refrigerant line of the condenser 620, and the second temperature sensor 626 can be provided in the vicinity of the length of the refrigerant line of the condenser 620 for sensing the phase change temperature.

In the meantime, in general, each of the evaporator 630 and the condenser 620 has a predetermined length of refrigerant line and a plurality of heat exchange fins (not shown) fixedly secured to the refrigerant line for increasing heat exchange efficiency. In this case, the middle portion of the refrigerant line can overlap with the heat exchange fins, making mounting and securing of the first and second temperature sensors 626 and 636 difficult.

Therefore, it is preferable that the first or second temperature sensor 626 or 636 is positioned on a portion of the refrigerant line the first or second temperature sensor 626 or 636 does not overlap with the heat exchange fins. That is, the first or second temperature sensor 626 or 636 can be mounted on the refrigerant line exposed from one side of the heat exchange fin on the refrigerant line of the heat exchange fins and the refrigerant line passed through the heat exchange fins of the evaporator 630 or the condenser 620. In this case too, it is preferable that the position of mounting of the first or second temperature sensor 626 or 636 is in the vicinity of the middle portion of the refrigerant line.

In the meantime, when used for a long time period, the related art cloth treating apparatus 1 with the heat pump 600 causes blocking of a flow passage of the dried air as the lint from the drying objects is caught at a surface of the condenser 620 and the evaporator 630 at which the heat exchange takes place, interfering with the heat exchange between the evaporator 630 and the condenser 620 and the air passing through the heat pump 600, thereby making efficiency of the heat pump 600 poor.

The air flow passage of the cloth treating apparatus is configured such that the air passes through the condenser 620 after the air passes through the evaporator 630. Accordingly, the lint from the drying objects is caught at the evaporator 630 more than the condenser 620. Therefore, means for removing the lint from the evaporator 630 is required.

Means for removing the lint from the heat pump in accordance with a preferred embodiment of the present invention will be described in detail, with reference to the attached drawings.

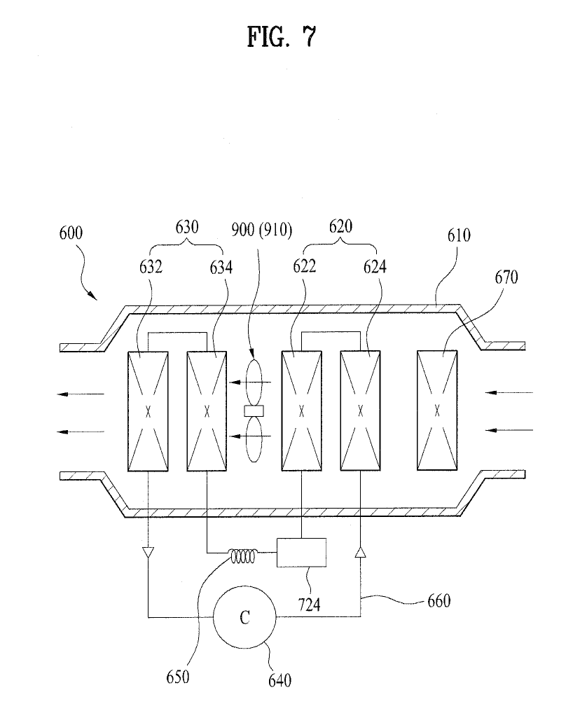

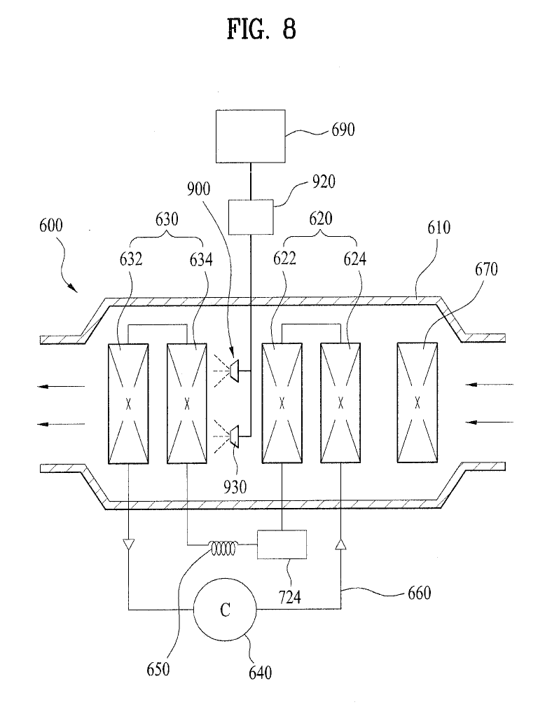

FIGS. 7 and 8 illustrate schematic views of lint removing means from heat pump modules in accordance with preferred embodiments of the present invention, respectively.

In the meantime, the cloth treating apparatus 1 shown in FIG. 4 of the present invention is provided with the fan 310 for circulation of the air. In this case, the air is circulated in one direction by the fan 310, and the lint accumulates on the evaporator 630 of the heat pump 600 as the air circulates.

Therefore, if a direction of air blow of the fan 310 is reversed, the lint accumulated on the evaporator 630 will be separated from the evaporator 630 by an air blow pressure. Accordingly, in order to remove the lint from the heat pump 600, an axial fan which is reversible is provided as the fan 310 for driving the fan 310 in the reverse direction at the time of removal of the lint.

In the meantime, the fan 310 of cloth treating apparatus 1 which circulates the air at the time of drying the drying objects has a problem in that the air blowing pressure is more or less weak for removing the lint from the evaporator 630.

Therefore, referring to FIG. 7, a supplementary fan 910 can be provided at a rear end of the evaporator 630 of the heat pump 600 as separate lint removal means, additionally. FIG. 6 illustrates a schematic view of the lint removal means in the heat pump in accordance with a preferred embodiment of the present invention.

As shown, a supplementary fan 910 can be provided between the evaporator and the condenser of the heat pump 600, additionally. The supplementary fan 910 blows air in a direction the same with the fan 310 at the time of drying the drying objects of the cloth treating apparatus 1, for circulating more air at the time of drying the drying objects.

And, at the time the lint is removed from the heat pump 600, the air is blown in a direction opposite to the direction of drying of the drying objects, for removing the lint from the evaporator 630. In this instance, both the fan 310 and the supplementary fan 910 can be driven to remove the lint, or only the supplementary fan 910 can be driven singly while the fan 310 is stationary for removing the lint from the evaporator 630.

Accordingly, it is preferable that the supplementary fan 910 is axial fan which is reversible for blowing the air in either direction in the heat pump 600.

In the meantime, if the cloth treating apparatus 1 is used for a long time, the lint from the drying objects is stuck to the evaporator 630. In this case, it is difficult to remove the lint by means of the reverse direction air blow of the fan 310 and the supplementary fan 910. Accordingly, additional means for changing the lint stuck to the evaporator 630 to be fluidic.

Accordingly, lint removal means from the heat pump in accordance with another preferred embodiment of the present invention will be described in detail, with reference to the attached drawings. In this instance, the lint removal means in accordance with another preferred embodiment of the present invention is additional to the lint removal means in accordance with the preferred embodiment of the present invention. Therefore, it is required to understand that the another preferred embodiment with reference to the preferred embodiment, and elements described hereafter are required to understand with reference to the description and the drawings of the preferred embodiment.

FIG. 8 illustrates a schematic view of lint removal means in accordance with another preferred embodiment of the present invention.

The lint removal means 900 in accordance with another preferred embodiment of the present invention utilizes the condensed water collected at the condensed water tank 690 for providing fluidity to the lint stuck to the evaporator 630.

For this, the lint removal means 900 is provided with a spray nozzle 930 for providing fluidity to the lint stuck to the evaporator 630 by spraying the condensed water from the condensed water tank 690 to the evaporator 630. The spray nozzle 930 has the condensed water supplied thereto from the condensed water tank 690 through a condensed water supply line 692 connected to the condensed water tank 690. And, the condensed water supply line 692 can have a spray pump 920 provided thereto for supplying the condensed water at a predetermined pressure.

Accordingly, if the condensed water is formed at the evaporator 630 and filled in the condensed water tank 690 as the cloth treating apparatus 1 is operated, the spray pump 920 is come into operation to supply the condensed water to the spray nozzle 930 through the condensed water supply line 692. The condensed water supplied to the spray nozzle 930 thus is sprayed to the evaporator 630 to provide fluidity to the lint stuck to the evaporator 630. In this instance, a direction of spray of the spray nozzle 930 which sprays the condensed water to the evaporator is opposite to the air blow direction at the time of drying the drying objects.

In this instance, alike the embodiment described before, the fan 310 or the supplementary fan 910 blows the air in a direction opposite to the direction at the time of drying, to increase an effect of removing the lint of which fluidity is increased by the condensed water.

That is, if a condensed water spray direction of the spray nozzle 930 and the air flow direction are the same, an effect in which the lint is removed from the evaporator 630 by the spray of the condensed water as well as a supplementary effect in which the lint is removed from the evaporator 630 by the air can be obtained.

In this instance, the condensed water used in removal of the lint is sent to the condensed water tank 690 together with the condensed water formed at the evaporator 630. The condensed water sent to the condensed water tank 690 can be used again in removal of the lint, or supplied to the heating tank 711 of the steam generating unit 710, or drained to an outside of the cloth treating apparatus by the user.

The operation of the cloth treating apparatus in accordance with a preferred embodiment of the present invention will be described in detail. It is required that elements mentioned hereafter are understood with reference to above description and drawings. In the meantime, the cloth treating apparatus of the present invention is applicable both to an air discharge type cloth treating apparatus and a condensing type cloth treating apparatus.

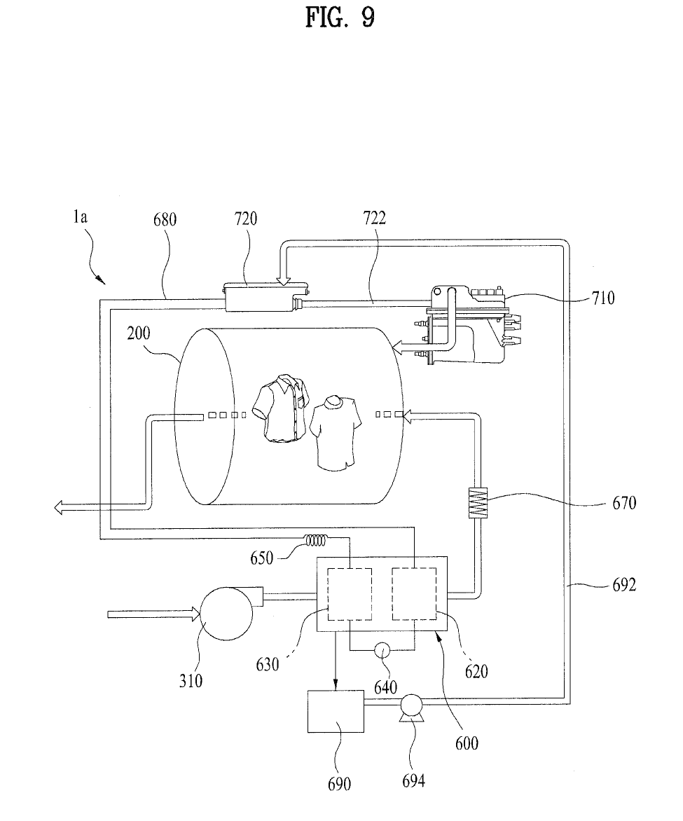

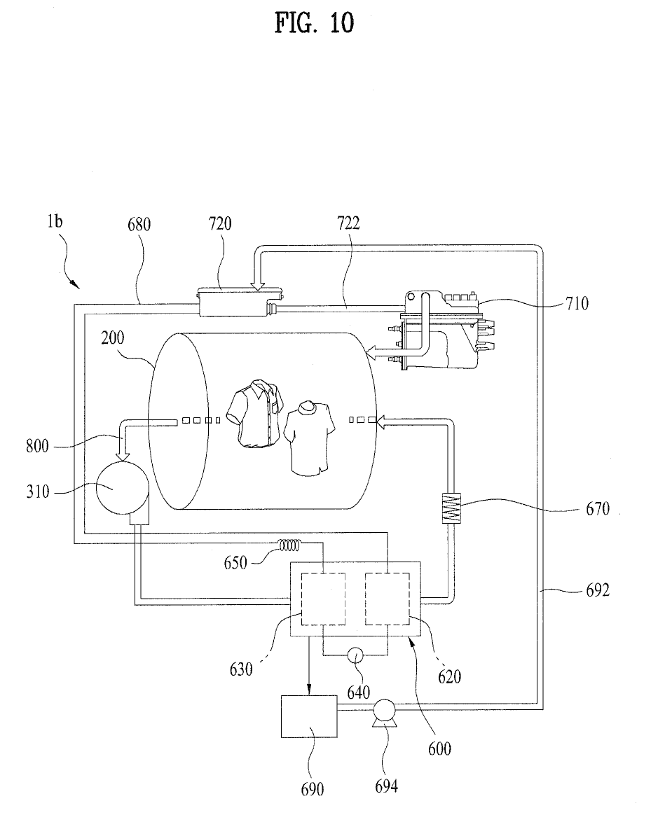

FIG. 9 illustrates a block diagram of a cloth treating apparatus in accordance with a preferred embodiment of the present invention, and FIG. 10 illustrates a block diagram of a cloth treating apparatus in accordance with another preferred embodiment of the present invention.

A structure and operation of the air discharge type cloth treating apparatus will be described with reference to FIG. 9.

FIG. 9 illustrates a schematic view of the air discharge type cloth treating apparatus 1a. In general, the air discharge type cloth treating apparatus 1a has no condenser provided thereto for condensing moisture from the humid air being discharged. That is, what is required for the air discharge type cloth treating apparatus 1a is just discharge of the humid air to an outside of the cloth treating apparatus. However, the cloth treating apparatus 1a of the embodiment is provided with the heat pump 600 for generation of the hot air, and the condensed water is formed at the evaporator 630 of the heat pump 600.

The air discharge type cloth treating apparatus 1a includes a drum 200 which is a laundry holding unit for holding laundry, a fan 310 for causing an air flow, a heat pump 600 for heating dried air being supplied to the laundry holding unit, an air discharge duct 400 for discharging humid air from the drum 200 to an outside of the cloth treating apparatus 1a, a steam generator 700 for generating steam to be supplied to the drum, a water supply unit 720 for holding the water to be supplied to the drum, a condensed water tank 690 for holding the condensed water formed at a drying apparatus, a steam supply line 715 for supplying the steam to the drum, and a condensed water supply line 692 for supplying the condensed water from the condensed water tank 690 to the water supply unit 720.

In the air discharge type cloth treating apparatus 1a, external air is introduced to the cloth treating apparatus 1a as the fan 310 is driven according to progress of a drying step, and is dehumidified and heated by the heat pump 600 while the air passes through the heat pump 600. In this instance, the air passing through the heat pump 600 is dehumidified by the evaporator 630 of the heat pump 600, heated by the condenser 620 and supplied to the drum in hot dried air. In addition to this, in order to heat the air passing through the heat pump 600 additionally, an additional supplementary heater 670 can be provided. However, if an air temperature required for drying the drying objects is met by the air heating of the heat pump 600, the supplementary heater 670 may not be provided.

As described before, in a process the hot dried air is supplied from the heat pump 600 to the drum 200, the refrigerant passed through the condenser 620 of the heat pump 600 is supplied to the water storage tank 724 of the water supply unit 720 in the steam generator 700 along the pre-heating flow passage 680. According to this, the water held in the water storage tank 724 of the water supply unit 720 is heated by the refrigerant passed through the condenser 620.

In the meantime, the steam generator 700 heats the water supplied from the water supply unit 720 to generate the steam, and the steam generated thus is supplied to the drum 200 through the nozzle. According to this, refresh of the drying objects can be performed in the drum 200.

In this instance, as described before, in a process the hot dried air is supplied from the heat pump 600 to the drum 200, the condensed water formed at the evaporator is held at the condensed water tank 690, supplied to the water storage tank 724 of the water supply unit 720, and can be used for steam generation, again.

In the meantime, referring to FIG. 10, the condensing type cloth treating apparatus 1b has an additional circulating duct 800 so that the hot dried air supplied to the drum 200 is supplied to the fan 310 again after drying the drying objects in the drum 200. Since the condensing type cloth treating apparatus 1b has a structure identical to a structure of the air discharge type cloth treating apparatus 1a, excluding the circulating duct 800, detailed description of the condensing type cloth treating apparatus 1b will be omitted.

Moreover, even though the embodiments of the present invention have been described taking the cloth treating apparatus 1 of which purpose is drying clothes as an example, the embodiments of the present invention are applicable to a washing and drying machine which can wash and dry clothes.

The cloth treating apparatus of the present invention improves structures of the heat pump and the steam generator which generate heat to generate hot air and steam to elevate an initial temperature of the water used for generation of the steam, thereby reducing power consumption of the steam generator.

The cloth treating apparatus of the present invention improves structures of the heat pump and the steam generator which generate heat to generate hot air and steam to elevate an initial temperature of the water used for generation of the steam, thereby increasing steam generation efficiency of the steam generator.

And, the cloth treating apparatus of the present invention can increase condensing efficiency and heating efficiency by using a plurality of evaporators and condensers, and can suppress noise and vibration to the minimum additionally by controlling a driving speed of the compressor with reference of an accurate refrigerant temperature.

Since the dryer of the present invention can remove lint carried by the air and accumulated on heat exchangers, such as the condenser or the evaporator, easily, permitting to secure a flow passage of air introduced to the heat pump, a performance of the heat pump can be improved.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A cloth treating apparatus comprising:
a cabinet which forms an exterior thereof;
a drum rotatably mounted to the cabinet;
a heat pump for supplying hot air to the drum;
a steam generator for supplying steam to the drum; and
a water tank for supplying water to the steam generator,
wherein the water tank is positioned on a refrigerant flow passage of the heat pump.

2. The cloth treating apparatus as claimed in claim 1, wherein the heat pump includes;
a compressor for supplying refrigerant,
a condenser for heating air by means of heat exchange with the refrigerant supplied by the compressor,
a flow passage of the refrigerant which passes through the condenser for heating the water being supplied to the steam generator,
an expander for expansion of the refrigerant which passes through the condenser, and
an evaporator for condensing the air by means of heat exchange with the refrigerant.

3. The cloth treating apparatus as claimed in claim 2, wherein the steam generator includes;
a steam generating unit for generating the steam, and
a water supply unit for holding the water to be supplied to the steam generating unit,
wherein the flow passage heats the water held in the water supply unit.

4. The cloth treating apparatus as claimed in claim 3, wherein the flow passage is lead into the water supply unit.

5. The cloth treating apparatus as claimed in claim 3, wherein the water supply unit has condensed water condensed at the evaporator supplied thereto.

6. The cloth treating apparatus as claimed in claim 1, further comprising a drying duct which forms a hot air moving passage, and the heat pump is coupled to the drying duct to form a modular shape.

7. The cloth treating apparatus as claimed in claim 2, wherein the evaporator is plural.

8. The cloth treating apparatus as claimed in claim 7, wherein the evaporator includes a first evaporator and a second evaporator arranged adjacent to the first evaporator, such that humid air from the drum passes through the first evaporator and the second evaporator in succession through one flow passage.

9. The cloth treating apparatus as claimed in claim 2, wherein the condenser is plural.

10. The cloth treating apparatus as claimed in claim 9, wherein the condenser includes a first condenser and a second condenser arranged adjacent to the first condenser, such that dried air passed through the evaporator passes through the first condenser and the second condenser in succession through one flow passage.

11. The cloth treating apparatus as claimed in claim 2, wherein the compressor is a variable compressor, and at least one temperature sensor is provided for sensing a temperature of the evaporator, the variable compressor, the condenser, the expansion valve, and a phase change temperature of the refrigerant.

12. The cloth treating apparatus as claimed in claim 11, wherein the temperature sensor is provided to the evaporator.

13. The cloth treating apparatus as claimed in claim 12, wherein the evaporator includes a refrigerant line through which the refrigerant flows, and heat exchange fins fixedly secured to the refrigerant line, and
the temperature sensor is mounted in the vicinity of a middle portion of the refrigerant line exposed from the heat exchange fins.

14. The cloth treating apparatus as claimed in claim 11, wherein the temperature sensor is provided to the condenser.

15. The cloth treating apparatus as claimed in claim 14, wherein the condenser includes a refrigerant line through which the refrigerant flows, and heat exchange fins fixedly secured to the refrigerant line, and
the temperature sensor is mounted in the vicinity of a middle portion of the refrigerant line exposed from the heat exchange fins.

16. The cloth treating apparatus as claimed in claim 2, wherein the heat pump further includes lint removing means for removing lint from the heat pump.

17. The cloth treating apparatus as claimed in claim 16, wherein the lint removing means includes a spray nozzle for receiving the condensed water from the evaporator and spraying the condensed water to the evaporator at a predetermined pressure.

18. The cloth treating apparatus as claimed in claim 16, wherein the lint removing means further includes a fan for blowing air to the drum, and the fan is provided as a reversible fan which can blow the air in regular/opposite directions for blowing the air in a direction opposite to a direction of the air blow at the time of drying at the time of lint removal.

19. A cloth treating apparatus comprising:
a cabinet which forms an exterior thereof;
a drum rotatably mounted to the cabinet;
a heat pump for supplying hot air to the drum; and
a steam generator for supplying steam to the drum,
wherein the water supplied to the drum is pre-heated by surplus heat of the heat pump.

20. A cloth treating apparatus for washing and drying clothes, comprising:
a heat pump for supplying hot air for drying the clothes; and
a steam generator for supplying steam to the clothes for refreshing the clothes,
wherein the water supplied to the steam generator is pre-heated by surplus heat of the heat pump.
